(19) United States
(12) Patent Application Publication
(10) Pub. No.: US 2011/0253622 A1
(43) Pub. Date: Oct. 20, 2011

(54) METHOD AND SYSTEM OF INDELIBLY MARKING CELLULOSE, PAPER, TEXTILES AND OTHER WOVEN AND NON-WOVEN FIBER MATERIALS

(76) Inventor: Salvatore Albert Celeste, Swampscott, MA (US)

(21) Appl. No.: 13/081,414

(22) Filed: Apr. 6, 2011

Related U.S. Application Data
(60) Provisional application No. 61/321,475, filed on Apr. 6, 2010.

(51) Int. Cl. A47J 31/06; B41F 23/04; B01D 39/18

(52) U.S. Cl. 210/504; 101/488

(57) ABSTRACT

The present invention provides a convenient and cost effective method of imprinting both text and images on certain filter materials such as those used in automatic coffee makers or as envelopes for the steeping of tea. The imprint must therefore be indelible, water resistant, non-toxic, temperature-resistant within the parameters of the application and the image reproduction must be crisp and permanent. Although the above-mentioned application is specific, it must be understood that the technology described herein includes, but is not limited to, the imprinting of filter paper and may be applied wherever indelible marking of certain appropriate substrates may be desired. The following describes both a method and system for indelibly marking a fabric, paper or any other fibrous material without the use of a pigmented liquid or thin-film transfer.

### BACKGROUND OF THE INVENTION

1. Field of the Invention

This invention relates generally to woven and non-woven fiber materials, for example as coffee filters and tea bags, and more particularly a method to imprint upon these items an indelible, non-toxic marking suitable for direct contact with food and beverages by means of a unique printing method.

2. Background Art

Presently, there exists a need for a method of printing on certain substrates, particularly those in direct contact with food. Unfortunately, many regulatory agencies worldwide acknowledge that many inks may adulterate the food or beverage in which they come in contact as the ink may be absorbed or otherwise transferred to the food product. It is for this reason that most ink or food dye methods are prohibited for use if the packaging or imprinted substrate may be immersed, wetted or in become in direct contact with any material intended for human consumption. One such example is the automatic drip coffee filter. It has long been a desire of filter manufacturers to imprint these filters with various designs such as company logos, measuring marks or other graphics. However, since the filter material is indeed in direct contact with the ground coffee, filter makers have had to use alternatives to printing such as embossing to avoid possible ink contamination. In many countries even food based dyes are considered to be unacceptable. In those few countries where inks and dyes are allowed, consumers tend to react negatively if the marking colors bleed or become faded during use as this indicates that the pigment has now infiltrated the beverage and is generally viewed as contamination. The problem is further exacerbated by the fact that the filter is usually subjected to hot water up to 100 degrees Celsius during the brewing process thus causing further degradation of the markings.
One purpose of this invention is to provide a convenient and cost effective method of imprinting onto a substrate such as a coffee filter, an indelible “ink-like” marking that is safe for use on products intended for human consumption. Another purpose of this invention is a method of non-toxic ink-less printing for use with otherwise untreated plain paper or cloth.

### DETAILED DESCRIPTION

The scope of the present invention consists of a method of marking and the associated equipment and materials necessary to reduce the method to practice. The indelible mark or graphic is achieved by first imprinting the substrate with a weak acid or other fluid that will degrade the surface of the treated fibers sufficiently to alter the flash point of the material. For example: Cellulose paper fibers have an average flash point (temperature at which auto-ignition can occur) of 450 degrees. If the surface of the fiber is treated with a weak solution of citric, acetic or other dilute acid, that fiber surface will degrade sufficiently to effectively lower the auto-ignition point of that surface. This allows the fiber to be superficially and quite visibly “scorched” at a temperature significantly below that of the surrounding (untreated) fibers or the internal core of the treated fiber itself. Therefore, when the fiber is subjected to sufficient heat energy, it is possible to cause a color change in the surface of the fiber without danger of destroying the fiber completely.

The principal practical application of this phenomenon is to “brand” or otherwise permanently etch an image onto paper or fabric without the application of pigments and having no danger of inadvertently igniting the material as is the case with other methods of hot-iron branding. One method of accomplishing this is as follows:

A sheet of bleached or non-bleached cellulose or other fiber paper is marked with a graphic (text, image or pattern) with acetic acid by means of screen-print, rubber stamp, offset press, inkjet or any other method of imprinting that lends itself to the purpose of this invention. The wetted area, in the form of the graphic is then allowed to dry and react with the paper surface sufficiently to degrade the surface of the underlying fibers. Note that the level of degradation is generally not visible to the unaided eye at this stage. Next the treated paper is irradiated with heat energy and the temperature of the paper is raised to 350 degrees Fahrenheit. This temperature is approximately 100 degrees below that of the temperature necessary to ignite the entire sheet of paper but is sufficient to cause a superficial scorching of the treated fibers. The color change can be best described as a “browning” or darkening of the top surface of the fiber and only as deep as the acid previously penetrated the paper surface. The result is similar in appearance to paper that has been branded with a hot branding iron but without the possibility of inadvertently igniting the entire sheet due to the temperatures needed above the paper flash point. It is foreseen that certain printing methods may require that the acidic liquid be modified to assume certain characteristics of printing inks. This may include thickening agents such as colloids or cellulose gelling agents and gums as well as other functional additives to facilitate the print process.

### DESCRIPTION OF THE PREFERRED EMBODIMENT

### Example 1

The primary embodiment addresses a need for indelibly marking certain paper goods without pigment or ink dyes that could possibly cause a contamination or adulteration of a food product in direct contact with the proposed marking. Such a condition exists with the marking of hot beverage filter papers such as those used in the preparation of coffee and teas. This embodiment is best described as a filter paper or die-cut and crimped filter basket or conic section for use in an automatic drip coffee machine having an image, text or combination thereof applied to the paper surface. In this particular example, the graphic applied is a measuring gradient for the purpose of determining the appropriate amount of ground coffee to be used to make a specific number of cups of the beverage. However, it is foreseen that the applied graphic may not have any particular utility beyond that of aesthetic enhancement or product identification.

Production of the final product may be reasonably accomplished in the following steps:

First, rolls of converted paper suitable for coffee filtration are dispensed into a manufacturing production line prior to die cutting, folding and seam-embossing or pleating to form the functional geometry of a coffee filter cone or basket. Prior to die-cutting or at some point convenient thereafter, it would be possible to place into an existing line of assembly, interstitial machinery to implement the aforementioned marking system. This may be comprised, but not limited to a “self-priming” rotary rubber stamp device similar to those commonly used to imprint images and text onto paper surfaces such as cartons and other shipping containers. This device consists of a hollow drum having a contact surface of a porous rubber-like polymer on its periphery. Embossed on the peripheral contact surface of the drum is a multiplicity of graphics or text, formed in raised positive relief. These relief images are analogous to the printing surface of a common rubber stamp except that it rotates under pressure as a surface is moved beneath it in a manner similar to a stationary wheel placed on a moving conveyor belt thus repeating the image or series of images each time the wheel makes a single revolution. The hollow of the drum acts a reservoir for acetic acid or other appropriate fluid designed for the task, that is exuded through the porous contact surface of the printing wheel each time an image becomes under pressure due to contact with the moving surface below. The drum's internal reservoir may be constantly supplied with additional etching fluid by means of an external reserve tank and feed tube integrated within the axel of the drum unit. FIG. 1 As the converted paper moves under the printing drum, the device rotates at the same speed thus repeating a stamped negative of the image in evenly spaced succession and “printed” in the etching solution. FIG. 2 After the print is briefly air-dried, the paper then passes under a heat lamp or successive heating elements exposing the imprinted area to hest radiation at approximately 350 degrees Fahrenheit and subsequently scorching the treated surfaces only. The image is now permanently etched onto the surface without any significant weakening of the effected fibers and no possibility of burning the surrounding untreated paper. The paper then progresses onto the die-cutting station for further manufacturing processes. FIG. 3 It may be noted that this process may be integrated into the production line at any point convenient or available. A similar configuration is foreseen to imprint the product post production as well.

### BRIEF DESCRIPTION OF THE DRAWINGS

FIG. 1 Is an example of a system capable of manufacturing the preferred embodiment final product The system is comprised of (1) having an external fluid reservoir tank having a filler cap and fluid refill access (2) to replenish the etching solution. (3) A feeder Rex (4) transfers the etching fluid to the internal fluid reservoir (5) by way of the hollow axel inlet (6) where the fluid is allowed to permeate the porous rubber transfer media (7) surrounding the reservoir drum. The face of the drum has several identical positive relief images (8) located at even intervals around the periphery of the drum unit, similar in construction to a common self-inking rubber stamp. As the filter paper or other printable substrate (9) is passed under the drum, an impression cylinder roller (10) presses the paper substrate against the positive reliefs causing an amount of etchant fluid to deposit itself on the paper of the image determined by the relief configuration. The impression roller is connected to a motor via the roller axel (11) that progresses the paper in a continuous feed cycle.

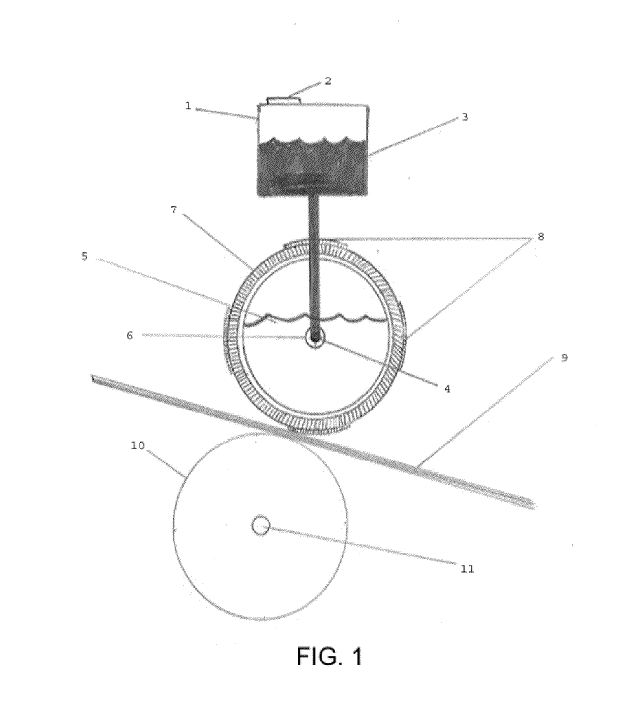

FIG. 2 Subsequent to moving past the print rollers, to the paper substrate (9) is then passed between two heater elements or other heat source (12) where the etchant treated areas of the substrate are heated to a temperature closed to the flashpoint of the degraded fibers causing the material to scorch (discolor) in the patterns produced by the rubber stamp reliefs. The adjacent untreated substrate material is left unchanged. Thus an indelible image is then produced.

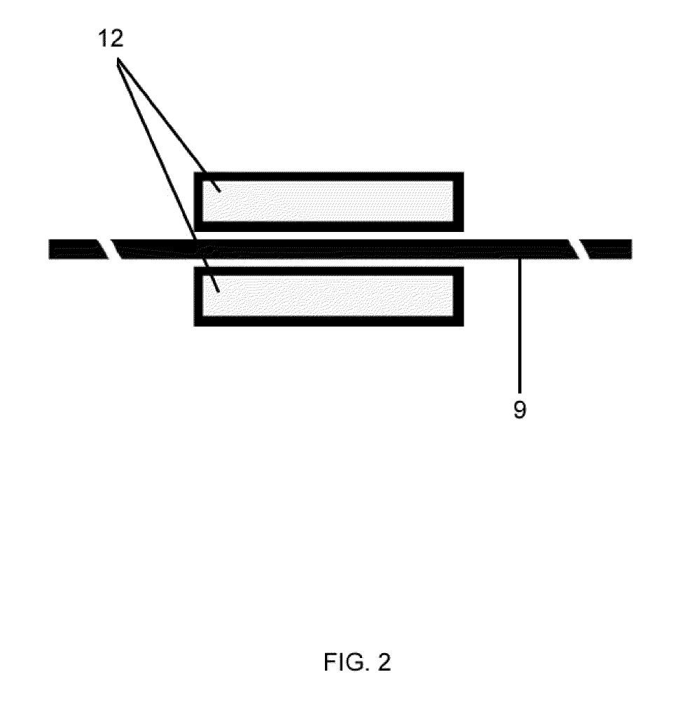

FIG. 3 Is a detailed view of the self-priming etchant transfer drum consisting of the internal drum reservoir (5), the axial feed tube, (6) the porous rubber transfer membrane. (7) and the raised positive image relief (8) that prints the etchant solution onto the substrate in the desired pattern.

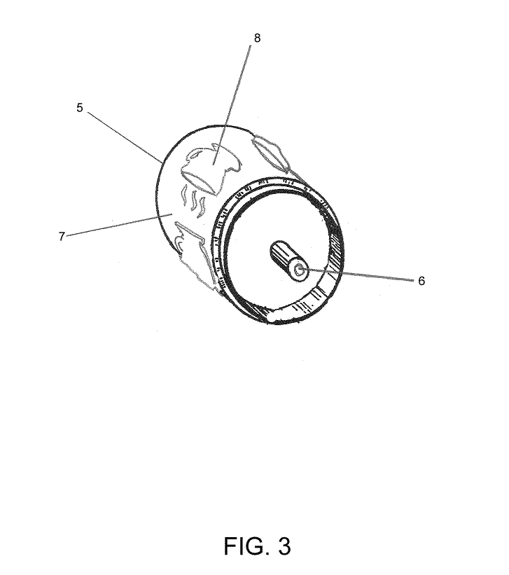

FIG. 4 Shows a detail of a filter paper substrate (9) with an image etched into the surface. In this example, a measuring gradient (13)

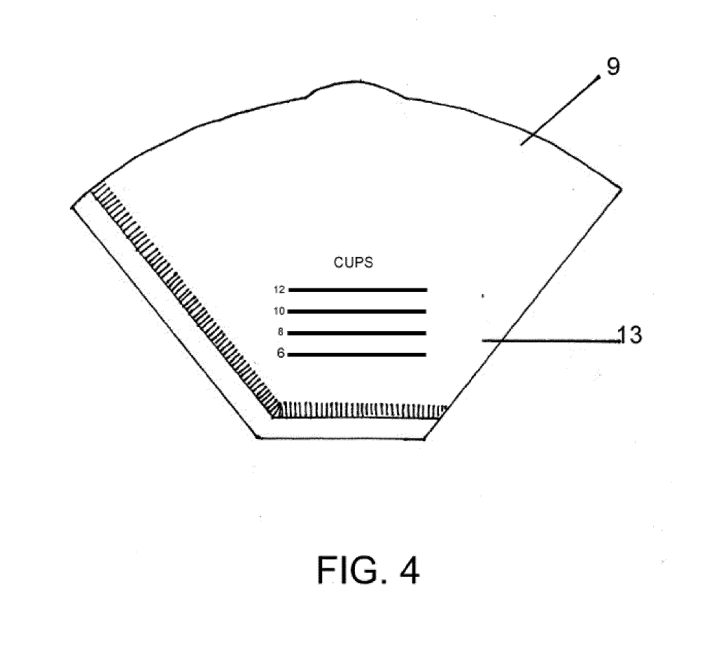

1. A coffee filter or tea bag having an acidic or other solution capable of degrading cellulose or other natural fiber as to alter the materials flash-point to a temperature less than that of the untreated fiber and applied by conventional printing methods for the purpose of creating a non-toxic, indelible image, pattern or text.

2. A method of ink-less printing where the image is printed using a solution to degrade the substrate fibers in a predetermined pattern and then heated to expose the latent image by discoloring the treated areas, including but not limited to the marking of substrates that may come in direct contact with a food or food related product.

3. A coffee filter as described in claim one having a non-toxic, indelible image, text or pattern applied thereto for the purpose of measuring the amount of coffee introduced into the filter.

4. A method of printing on coffee filters and other substrates that produces a latent image having the image applied by means of conventional printing methods, preferably a rotary rubber stamp or flexigraphic mechanism and then having the imprinted paper heated to the flash point of the treated fibers to produce the final image.

5. A method of printing where certain areas of a substrate are wetted in a pattern, image or text with a solution intended to degrade the fibers thereunder in order to alter the flash-point of the material.

6. A method of printing where the degraded fibers are subjected to temperatures less than the flash-point of the untreated material but greater than the flash-point of the treated fibers as described in claim 4 to reveal the latent image.

7. A coffee filter or tea bag as described in claim 1, where the image is produced by passing the filter in proximity to a heat source capable of scorching the areas treated with the weak acid solution.
